(19) United States
(12) Patent Application Publication
(10) Pub. No.: US 2026/0180500 A1
(43) Pub. Date: Jun. 25, 2026

(54) INSTALLATION STRUCTURE FOR STEEL FRAME ASSEMBLY

(71) Applicant: ANHUI CAESAR NEW ENGERY TECHNOLOGY CO.,LTD, Chuzhou (CN)

(72) Inventors: Xiaofeng HUANG, Chuzhou (CN); Siping XIE, Chuzhou (CN)

(21) Appl. No.: 19/386,215

(22) Filed: Nov. 11, 2025

(30) Foreign Application Priority Data
Sep. 30, 2025 (CN) 202511417690.5

(51) Int. Cl. H02S 30/10; F16M 13/02

(52) U.S. Cl. CPC H02S 30/10; F16M 13/02

(57) ABSTRACT

An installation structure for a steel frame assembly is provided, including: a steel frame, where the bottom of a main frame plate of the steel frame has a lower horizontal external flange vertically connected to an upward bent lower vertical flange on a side away from the main frame plate, and the lower vertical flange, the lower horizontal external flange, and the main frame plate enclose a limit cavity with a top opening, and the lower horizontal external flange is provided with a through hole; a T-bolt having an elongated head limited within the limit cavity, where two long sides of the elongated head abut against the main frame plate and the lower vertical flange respectively; and a purlin assembly provided with an installation hole, where a shank of the T-bolt passes through the through hole and the installation hole in sequence and is locked by a locking nut.

### CROSS REFERENCE TO RELATED APPLICATIONS

The present disclosure claims the priority to the Chinese patent application with the filing No. 2025114176905, entitled “INSTALLATION STRUCTURE FOR STEEL FRAME ASSEMBLY” and filed on Sep. 30, 2025 with the Chinese Patent Office, the contents of which are incorporated herein by reference in their entirety.

### TECHNICAL FIELD

The present disclosure relates to the field of solar photovoltaic technology, and more specifically, to an installation structure for a steel frame assembly.

### BACKGROUND

Due to energy shortage, countries around the world have intensified the development and utilization of new energy sources, greatly promoting the development of the photovoltaic market. New energy photovoltaic projects are flourishing around the world, raising more requirements for photovoltaic modules. However, conventional aluminum frame assemblies have the shortcomings of high fluctuations in raw material prices, high processing energy consumption, low mechanical strength, poor resistance to wind and snow loads, susceptibility to deformation, unsuitability for high-temperature environments, potential corrosion with steel brackets, etc. Steel frames precisely overcome these shortcomings. The steel frames are made of zinc aluminum magnesium materials. Compared with aluminum frames, the steel frames have stronger corrosion resistance and load resistance in extreme environments. Moreover, the steel frames are produced by conventional cold bending technology, which is based on mature equipment technology and low production costs, thereby reducing the costs of photovoltaic modules.

A steel frame assembly includes a solar photovoltaic panel 100 and a steel frame 1, where the solar photovoltaic panel is placed on the steel frame. In some existing technologies, the steel frame and purlins are usually connected by fasteners such as external hexagonal bolts. During installation, both hands are required to simultaneously fix a bolt head and a nut for tightening, so the operation is highly inconvenient. Moreover, the positions of the external hexagonal bolts are limited. When the solar photovoltaic panel shakes or vibrates with the wind, the external hexagonal bolts are prone to loosening. The loosening fasteners, on the one hand, lead to the cracking or loosening of the assembly to affect power generation, and on the other hand, require manual inspection and maintenance to increase overall maintenance costs.

Therefore, providing an easy-to-operate and stably connected installation structure for a steel frame assembly remains a pressing technical challenge for technical personnel in the art.

### SUMMARY

In view of this, the present disclosure provides an easy-to-operate and stably connected installation structure for a steel frame assembly.

In order to achieve the above objective, the present disclosure adopts the following technical solution:

An installation structure for a steel frame assembly includes:
a steel frame, where the bottom of a main frame plate of the steel frame has a lower horizontal external flange, and the lower horizontal external flange is vertically connected to an upward bent lower vertical flange on a side away from the main frame plate; the lower vertical flange, the lower horizontal external flange, and the main frame plate enclose a limit cavity with a top opening; and the lower horizontal external flange is provided with a through hole;
a T-bolt, where an elongated head of the T-bolt is limited within the limit cavity, and two long sides of the elongated head abut against the main frame plate and the lower vertical flange respectively; and
a purlin assembly, where the purlin assembly is provided with an installation hole, and a shank of the T-bolt passes through the through hole and the installation hole in sequence and is locked by a locking nut.

Based on the above technical solution, compared with existing technologies, the installation structure for a steel frame assembly in the present disclosure has the following advantages:
1. The installation structure is easy to install and unlikely to fall off: During installation, the T-bolt can be easily installed at a manually controlled angle into the through hole of the steel frame, while the installed T-bolt can be removed at a specific angle, making a photovoltaic module less likely to fall off during transportation and installation; and this installation method is particularly suitable for unmanned aerial vehicles to transport steel frame photovoltaic modules.
2. The installation structure can achieve pre-installation and save labor: Conventional frame assemblies need to be held with hands during installation and then locked with bolts. In this installation method, the T-bolt is pre-installed in the through hole of the steel frame before the steel frame assembly is transported, then the steel frame assembly is placed on the purlin assembly, and the T-bolt is installed in the installation hole of the purlin assembly, where the steel frame assembly does not need to be held with hands in the locking process.
3. The steel frame is reinforced and installed firmly and reliably: The steel frame at the through hole is weakest due to the reduced cross-section, while the elongated head of the T-bolt can completely cover the through hole on the steel frame, thereby reinforcing the weak position of the steel frame and making the steel frame assembly firm and reliable after installation.
4. The T-bolt that does not rotate is quick to install, with good anti-loosening effect: In the locking process of the T-bolt, the elongated head of the T-bolt is limited by the main frame plate and the lower vertical flange of the steel frame, so the T-bolt will not rotate, has good anti-loosening effect and stable connection, and can be locked by operating an electric tool with one hand and installed quickly. However, a conventional external hexagonal bolt needs to be locked with two tools (one for fixing a bolt head and the other one for fixing a nut) during installation. The locked T-bolt will not rotate and has a very good anti-loosening effect, which can significantly reduce later operating costs of a photovoltaic power station.

Further, the installation structure includes a reinforcing gasket placed between the elongated head and the lower horizontal external flange, one side of the reinforcing gasket has a first clamping slot for the adaptive insertion of the shank of the T-bolt, and the height of the reinforcing gasket is less than that of the lower vertical flange.

The beneficial effects of the above technical solution are as follows: The lower horizontal external flange is provided with the through hole, which reduces the structural strength in that area. Therefore, the reinforcing gasket covering that area can increase the structural strength, the lower horizontal external flange in that area receives more uniform pressure from the bolt, the weak position is reinforced, and the steel frame assembly is more secure and reliable after installation.

Further, the purlin assembly includes: a first purlin, where the first purlin is a C-shaped purlin, an upper transverse plate of which is provided with the installation hole.

Further, the purlin assembly includes:
a second purlin, where the second purlin is a C-shaped purlin, an upper transverse plate of which has a downward bent installation flange; and
a U-shaped clamping block, where a middle plate of the U-shaped clamping block is provided with the installation hole and an elongated limit clamping slot, and the installation flange is inserted into the elongated limit clamping slot.

The beneficial effects of the above technical solution are as follows: The installation flange is inserted into the elongated limit clamping slot to achieve quick connection between the second purlin and the U-shaped clamping block, so additional holes are not required on the second purlin and the processing cost is greatly lowered.

Further, an interlocking plate is fixed on one side of each of two side plates of the U-shaped clamping block, the two interlocking plates abut against each other, and one or two installation holes are designed away from the interlocking plates.

The beneficial effects of the above technical solution are as follows: The U-shaped clamping block is provided with the interlocking plates, so when the steel frame assembly is compressed along the axis of the purlin, the U-shaped clamping block is less prone to deformation, and the service life of the U-shaped clamping block is prolonged.

Further, lower edges of the two side plates are avoidance arc surfaces; and the two side plates have reinforcing ribs.

The beneficial effects of the above technical solution are as follows: The avoidance arc surfaces can minimize interference between the hand and the U-shaped clamping block when the locking nut is tightened or loosened, facilitating installation; and the reinforcing ribs stamped on the two side plates increase the strength of the U-shaped clamping block to prevent its deformation.

Further, the installation structure includes an L-shaped stopper, where a transverse plate of the L-shaped stopper is fixedly connected to the upper transverse plate through a connecting bolt, and a vertical plate of the L-shaped stopper is stopped on one side of the steel frame on a side.

The beneficial effect of the above technical solution is as follows: The steel frame assembly on the side is provided with the L-shaped stopper, which prevents the steel frame assembly from moving along the axis of the second purlin.

Further, the purlin assembly includes:
a third purlin, where a top surface of the third purlin is provided with the installation hole; and
a stationary fixture, where the top of the stationary fixture is clamped with the steel frame, and the bottom of the stationary fixture is clamped between a bottom surface of the lower horizontal external flange and the top surface of the third purlin.

Further, the top of the main frame plate has an upper horizontal external flange, the upper horizontal external flange is vertically connected to an upward bent upper vertical flange on a side away from the main frame plate, and the upper vertical flange is vertically connected to an upper horizontal internal flange on a side away from the upper horizontal external flange; and
the top of a main fixture plate of the stationary fixture is vertically connected to an upper crimping edge, and the upper crimping edge is crimped with the upper horizontal internal flange; one side of the main fixture plate is vertically connected to a supporting edge, the supporting edge is located below the upper crimping edge, and the supporting edge supports the upper horizontal external flange; one side of the main fixture plate is vertically connected to a lower crimping edge at a position below the supporting edge, and the lower crimping edge is crimped with the elongated head; the bottom of the main fixture plate is vertically connected to a reinforcing crimping edge, and the reinforcing crimping edge is clamped between a bottom surface of the lower horizontal external flange and the top surface of the third purlin.

The beneficial effects of the above technical solution are as follows: The upper crimping edge is crimped with the upper horizontal internal flange, so that when the steel frame assembly is subjected to back load, support can be provided for the steel frame assembly to withstand the back load, thereby improving the strong wind resistance of the steel frame assembly; the supporting edge supports the upper horizontal external flange, so that when the steel frame assembly is subjected to downward load, reverse support can be provided for the steel frame assembly, thereby improving the bearing capacity of the steel frame to a certain extent, enhancing the deformation resistance and pressure bearing capacity of the steel frame, and improving the wind and snow resistance of the steel frame assembly; the steel frame assembly is installed on the third purlin by the T-bolt, where the use of the T-bolt increases the contact area between the bolt and the steel frame, increases the stress area, and improves the stability of the steel frame assembly under stress; the lower crimping edge is crimped with the elongated head, and the length of the lower crimping edge can pass through the center point of the T-bolt, thereby ensuring the stability of the T-bolt, limiting the displacement of the T-bolt, and preventing loosening; the combined effect of the lower crimping edge and the elongated head covers the through hole of the steel frame, enhances the pressure bearing capacity and deformation resistance of the steel frame, and improves the load bearing capacity and stability of a photovoltaic bracket; and the reinforcing crimping edge is clamped between the bottom surface of the lower horizontal external flange and the top surface of the third purlin, whereby the reinforcing crimping edge increases the strength at the connection between the steel frame assembly and the purlin, ensuring the stability of the connection between the steel frame assembly and the purlin, and improving the pressure bearing capacity of the steel frame assembly.

Further, one side of the reinforcing crimping edge has a second clamping slot for the adaptive insertion of the shank of the T-bolt.

The beneficial effect of the above technical solution is as follows: The reinforcing crimping edge can be directly inserted between the bottom surface of the lower horizontal external flange and the top surface of the third purlin, facilitating the installation of the stationary fixture.

### BRIEF DESCRIPTION OF THE DRAWINGS

In order to describe technical solutions in embodiments of the present disclosure or the prior art more clearly, the following briefly introduces the accompanying drawings required for describing the embodiments or the prior art. Apparently, the accompanying drawings in the following description show only some embodiments of the present disclosure, and those of ordinary skilled in the art may still derive other drawings from these drawings without any creative efforts.

FIG. 1 is a schematic structural diagram of an installation structure for a steel frame assembly according to the present disclosure.

FIG. 2 is a schematic diagram showing that a T-bolt is horizontally put into an accommodating cavity of a steel frame.

FIG. 3 is a schematic diagram showing that the T-bolt is rotated by a certain angle and aligned with a through hole on the steel frame.

FIG. 4 is a schematic diagram showing that the T-bolt is rotated by a certain angle until an elongated head of the T-bolt is clamped in the accommodating cavity of the steel frame.

FIG. 5 is a schematic diagram showing that the steel frame pre-installed with the T-bolt is placed above a purlin assembly and aligned with an installation hole of the purlin assembly to achieve a pre-installation purpose.

FIG. 6 is a schematic diagram showing that the steel frame is fixed on the purlin assembly.

FIG. 7 is a schematic diagram showing that a first clamping slot of a reinforcing gasket placed after the T-bolt is lifted is aligned with a shank.

FIG. 8 is a schematic diagram showing that the reinforcing gasket is inserted into the accommodating cavity of the steel frame.

FIG. 9 is a schematic top view of an installation structure for a steel frame assembly according to a second embodiment of the present disclosure.

FIG. 10 is a schematic diagram showing that two adjacent steel frames in the middle are assembled with a purlin assembly in FIG. 9.

FIG. 11 is a schematic diagram showing that a steel frame on a side is assembled with a purlin assembly in FIG. 9.

FIG. 12 is a schematic diagram of a U-shaped clamping block in a first embodiment.

FIG. 13 is a schematic diagram of a U-shaped clamping block in a second embodiment.

FIG. 14 is a schematic diagram showing that the U-shaped clamping block in FIG. 13 is assembled with two adjacent steel frames in the middle.

FIG. 15 is a schematic top view of an installation structure for a steel frame assembly according to a third embodiment of the present disclosure.

FIG. 16 is a schematic diagram of FIG. 15 from another perspective.

FIG. 17 is a three-dimensional structural diagram showing that a stationary fixture, a steel frame, and a second purlin in FIG. 15 are assembled.

FIG. 18 is a front structural diagram of FIG. 17.

FIG. 19 is a schematic structural diagram of a stationary fixture.

FIG. 20 is a schematic structural diagram of a steel frame.

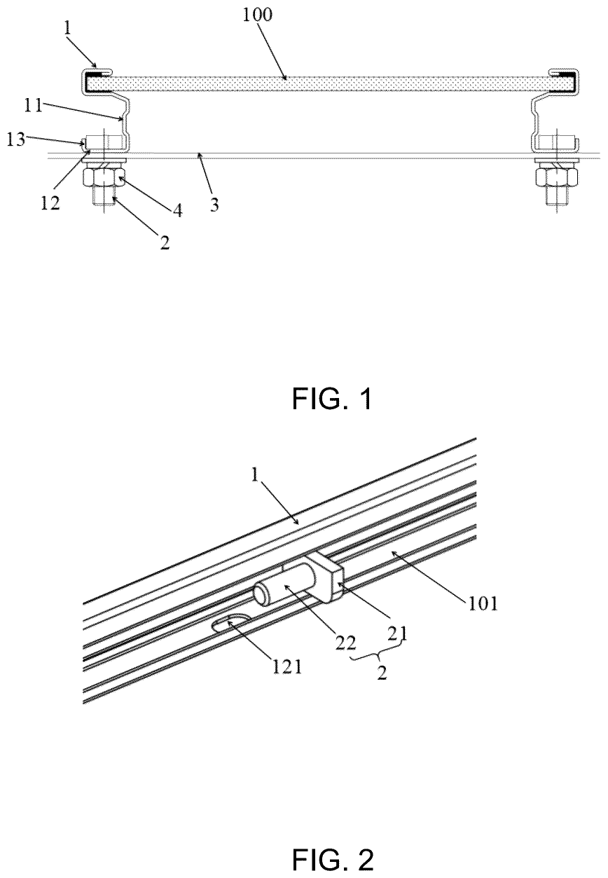

### DETAILED DESCRIPTION

The embodiments of the present disclosure will be described in detail below. Examples of the embodiments are shown in the accompanying drawings. The same or similar reference signs throughout the drawings denote the same or similar elements or elements having the same or similar functions. The examples described below with reference to the drawings are illustrative and are intended to explain the present disclosure, but cannot be interpreted as limiting the present disclosure.

In the description of the present disclosure, it should be understood that the orientations or positional relationships indicated by the terms “upper”, “lower”, “front”, “rear”, “left”, “right”, “vertical”, “horizontal”, “top”, “bottom”, “inner”, “outer”, etc. are based on the orientations or positional relationships shown in the drawings, are merely for the convenience of describing the present disclosure and simplifying the description, do not indicate or imply that a device or element referred to must have a specific orientation or be constructed and operated in a specific orientation, and therefore, cannot be understood as limitations of the present disclosure.

In addition, the terms “first” and “second” are merely used for a description purpose, and cannot be interpreted as indicating or implying relative importance or implicitly indicating the quantity of the indicated technical features. Thus, a feature defined by the term “first” or “second” may explicitly or implicitly include one or more of the feature. In the description of the present invention, “a plurality of” means two or more, unless otherwise specifically limited.

In the present disclosure, unless otherwise specified and limited, the terms “installation”, “connection”, “connected”, “fixation”, etc. should be understood in a broad sense. For example, the term “connection” may be fixed connection, detachable connection, integration, mechanical connection, electrical connection, direct connection, indirect connection by a medium, internal communication of two elements, or interaction between two elements. A person of ordinary skill in the art may understand the specific meanings of the above terms in the present disclosure according to specific situations.

An embodiment of the present disclosure discloses an installation structure for a steel frame assembly, including:
a steel frame 1, where a bottom end of a main frame plate 11 of the steel frame 1 has a lower horizontal external flange 12, and the lower horizontal external flange 12 is vertically connected to an upward bent lower vertical flange 13 on a side away from the main frame plate 11; the lower vertical flange 13, the lower horizontal external flange 12, and the main frame plate 11 enclose a limit cavity 101 with a top opening; the lower horizontal external flange 12 is provided with a through hole 121;
a T-bolt 2, where an elongated head 21 of the T-bolt 2 is limited within the limit cavity 101, and two long sides of the elongated head 21 abut against the main frame plate 11 and the lower vertical flange 13 respectively; and
a purlin assembly 3, where the purlin assembly 3 is provided with an installation hole 3211, and a shank 22 of the T-bolt 2 passes through the through hole 121 and the installation hole 3211 in sequence and is locked by a locking nut 4.

The installation structure for a steel frame assembly further includes a reinforcing gasket 5 placed between the elongated head 21 and the lower horizontal external flange 12, one side of the reinforcing gasket 5 has a first clamping slot 51 for the adaptive insertion of the shank 22 of the T-bolt 2, and the height of the reinforcing gasket 5 is less than that of the lower vertical flange 13. Such design can still ensure that the two long sides of the elongated head 21 abut against the main frame plate 11 and the lower vertical flange 13 respectively, thereby preventing the rotation of the elongated head 21.

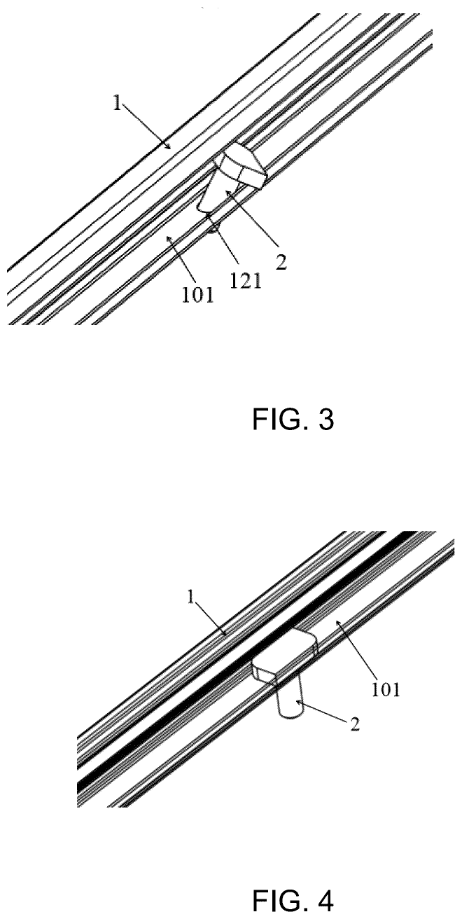

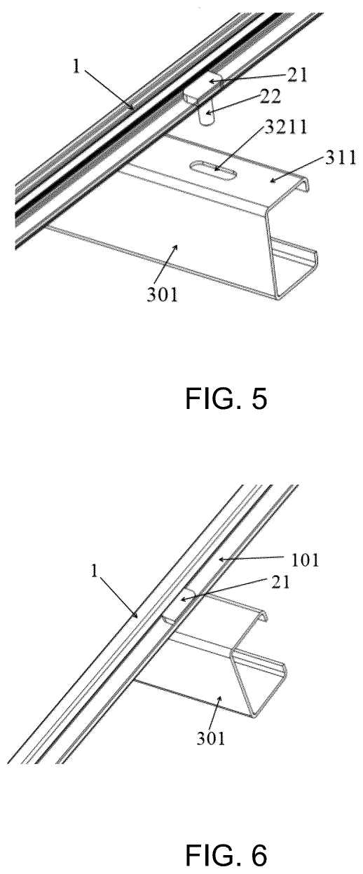

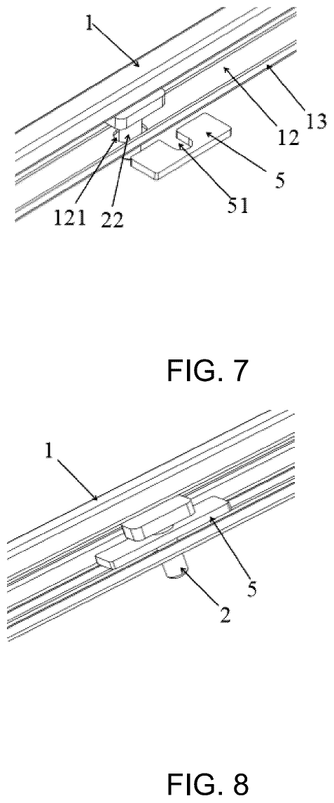

As shown in FIG. 2 to FIG. 6, the purlin assembly 3 in a first embodiment includes: a first purlin 301, where the first purlin 301 is a C-shaped purlin, an upper transverse plate 311 of which is provided with the installation hole 3211.

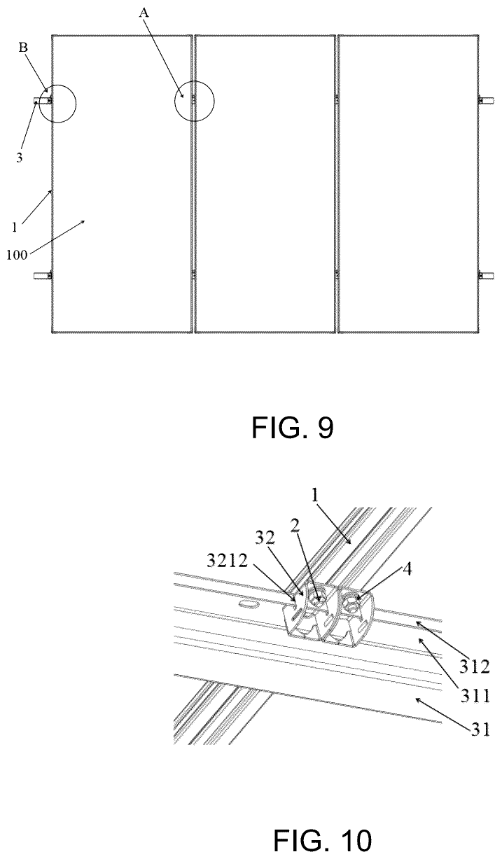

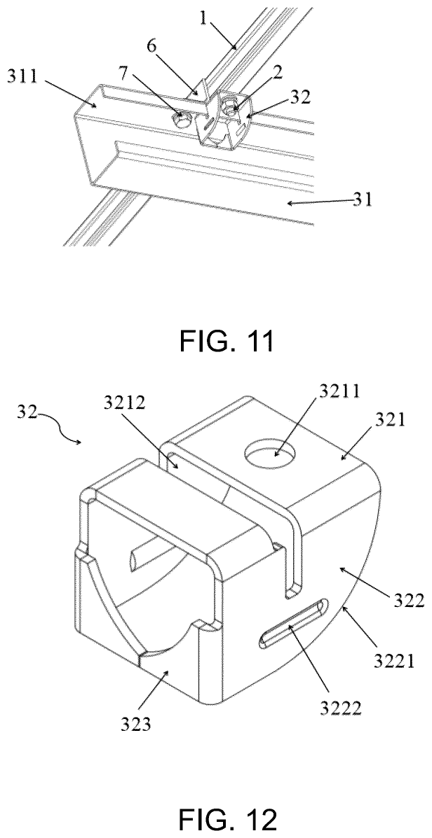

As shown in FIG. 9 to FIG. 14, the purlin assembly 3 in a second embodiment includes:
a second purlin 31, where the second purlin 31 is a C-shaped purlin, an upper transverse plate 311 of which has a downward bent installation flange 312; and
a U-shaped clamping block 32, where a middle plate 321 of the U-shaped clamping block 32 is provided with the installation hole 3211 and an elongated limit clamping slot 3212, and the installation flange 312 is inserted into the elongated limit clamping slot 3212.

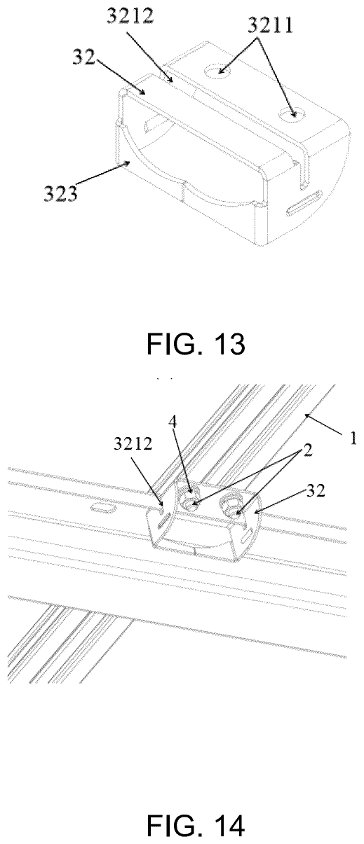

An interlocking plate 323 is fixed on one side of each of two side plates 322 of the U-shaped clamping block 32, the two interlocking plates 323 abut against each other, and one or two installation holes 3211 are designed away from the interlocking plates 323. Specifically, as shown in FIG. 10 and FIG. 12, one installation hole 3211 is designed, and the two adjacent steel frames 1 in the middle are installed with the U-shaped clamping blocks 32 respectively. As shown in FIG. 13 and FIG. 14, two installation holes are designed, and the two adjacent steel frames 1 in the middle may share one U-shaped clamping block 32, reducing the quantity of U-shaped clamping blocks 32 and thus lowering installation costs.

Lower edges of the two side plates 322 are avoidance arc surfaces 3221; and the two side plates 322 have reinforcing ribs 3222.

The installation structure for a steel frame assembly further includes an L-shaped stopper 6, a transverse plate of the L-shaped stopper 6 is fixedly connected to the upper transverse plate 311 through a connecting bolt 7, and a vertical plate of the L-shaped stopper 6 is stopped on one side of the steel frame 1 on a side.

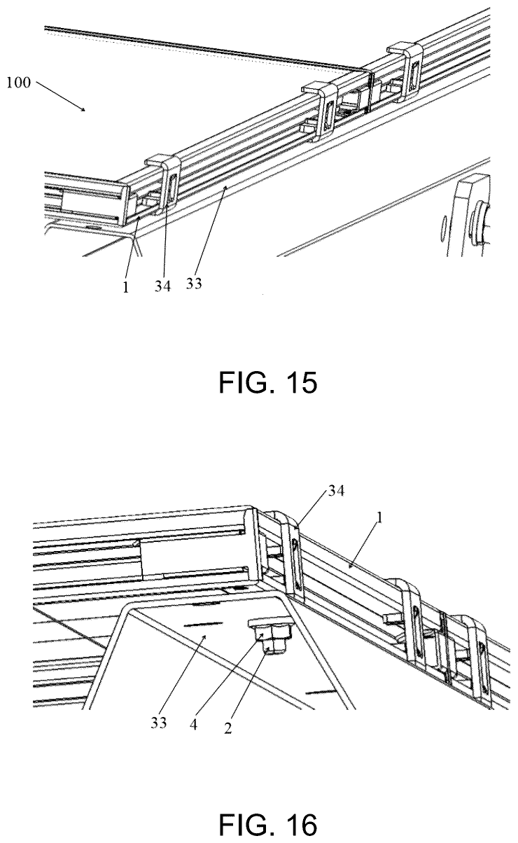

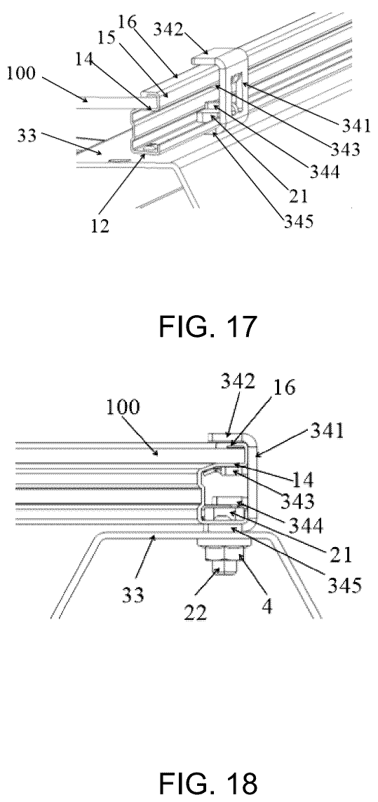

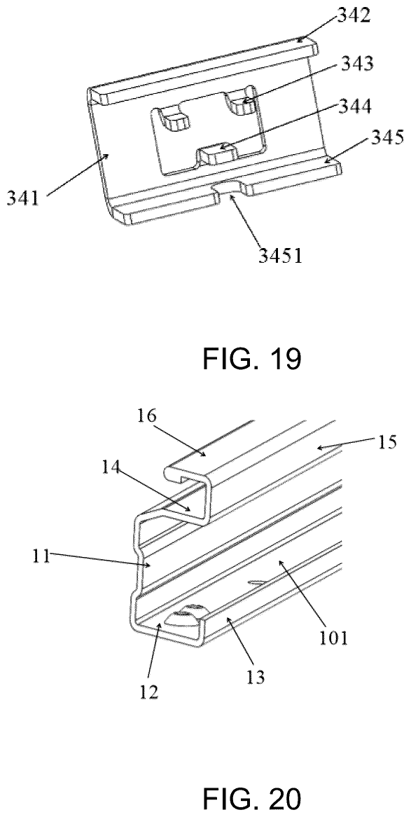

As shown in FIG. 15 to FIG. 20, the purlin assembly 3 in a third embodiment includes:
a third purlin 33, where a top surface of the third purlin 33 is provided with the installation hole 3211; and
a stationary fixture 34, where the top of the stationary fixture 34 is clamped with the steel frame 1, and the bottom of the stationary fixture 34 is clamped between a bottom surface of the lower horizontal external flange 12 and the top surface of the third purlin 33.

The top of the main frame plate 11 has an upper horizontal external flange 14, the upper horizontal external flange 14 is vertically connected to an upward bent upper vertical flange 15 on a side away from the main frame plate 11, and the upper vertical flange 15 is vertically connected to an upper horizontal internal flange 16 on a side away from the upper horizontal external flange 14;
The top of a main fixture plate 341 of the stationary fixture 34 is vertically connected to an upper crimping edge 342, and the upper crimping edge 342 is crimped with the upper horizontal internal flange 16; one side of the main fixture plate 341 is vertically connected to a supporting edge 343, the supporting edge 343 is located below the upper crimping edge 342, and the supporting edge 343 supports the upper horizontal external flange 14; one side of the main fixture plate 341 is vertically connected to a lower crimping edge 344 at a position below the supporting edge 343, and the lower crimping edge 344 is crimped with the elongated head 21; the bottom of the main fixture plate 341 is vertically connected to a reinforcing crimping edge 345, and the reinforcing crimping edge 345 is clamped between a bottom surface of the lower horizontal external flange 12 and the top surface of the third purlin 33.

One side of the reinforcing crimping edge 345 has a second clamping slot 3451 for the adaptive insertion of the shank 22 of the T-bolt 2.

The upper crimping edge is crimped with the upper horizontal internal flange, so that when the steel frame assembly is subjected to back load, support can be provided for the steel frame assembly to withstand the back load, thereby improving the strong wind resistance of the steel frame assembly; the supporting edge supports the upper horizontal external flange, so that when the steel frame assembly is subjected to downward load, reverse support can be provided for the steel frame assembly, thereby improving the bearing capacity of the steel frame to a certain extent, enhancing the deformation resistance and pressure bearing capacity of the steel frame, and improving the wind and snow resistance of the steel frame assembly; the steel frame assembly is installed on the third purlin by the T-bolt, where the use of the T-bolt increases the contact area between the bolt and the steel frame, increases the stress area, and improves the stability of the steel frame assembly under stress; the lower crimping edge is crimped with the elongated head, and the length of the lower crimping edge can pass through the center point of the T-bolt, thereby ensuring the stability of the T-bolt, limiting the displacement of the T-bolt, and preventing loosening; the combined effect of the lower crimping edge and the elongated head covers the through hole of the steel frame, enhances the pressure bearing capacity and deformation resistance of the steel frame, and improves the load bearing capacity and stability of a photovoltaic bracket; and the reinforcing crimping edge is clamped between the bottom surface of the lower horizontal external flange and the top surface of the third purlin, whereby the reinforcing crimping edge increases the strength at the connection between the steel frame assembly and the purlin, ensuring the stability of the connection between the steel frame assembly and the purlin, and improving the pressure bearing capacity of the steel frame assembly.

The embodiments in this specification are all described in a progressive manner, each embodiment focuses on differences from other embodiments, and the same or similar parts of the embodiments may be referenced to each other. The device disclosed in embodiments corresponds to the method disclosed in embodiments and is thus described relatively simply, and reference may be made to the description of the method for related parts.

The above descriptions of the disclosed embodiments enable those skilled in the art to implement or use the present disclosure. Various modifications to these embodiments are obvious to those skilled in the art, and the general principles defined herein may be implemented in other embodiments without departing from the spirit or scope of the present disclosure. Therefore, the present disclosure will not be limited to the embodiments described herein, but extends to the widest scope that complies with the principle and novelty disclosed herein.

1. An installation structure for a steel frame assembly, comprising:
a steel frame, wherein the bottom of a main frame plate of the steel frame has a lower horizontal external flange, and the lower horizontal external flange is vertically connected to an upward bent lower vertical flange on a side away from the main frame plate; the lower vertical flange, the lower horizontal external flange, and the main frame plate enclose a limit cavity with a top opening; and the lower horizontal external flange is provided with a through hole;
a T-bolt, wherein an elongated head of the T-bolt is limited within the limit cavity, and two long sides of the elongated head abut against the main frame plate and the lower vertical flange respectively; and
a purlin assembly, wherein the purlin assembly is provided with an installation hole, and a shank of the T-bolt passes through the through hole and the installation hole in sequence and is locked by a locking nut.

2. The installation structure for a steel frame assembly according to claim 1, further comprising a reinforcing gasket placed between the elongated head and the lower horizontal external flange, wherein one side of the reinforcing gasket has a first clamping slot for the adaptive insertion of the shank of the T-bolt, and the height of the reinforcing gasket is less than that of the lower vertical flange.

3. The installation structure for a steel frame assembly according to claim 1, wherein the purlin assembly comprises: a first purlin, wherein the first purlin is a C-shaped purlin, an upper transverse plate of which is provided with the installation hole.

4. The installation structure for a steel frame assembly according to claim 1, wherein the purlin assembly comprises:
a second purlin, wherein the second purlin is a C-shaped purlin, an upper transverse plate of which has a downward bent installation flange; and
a U-shaped clamping block, wherein a middle plate of the U-shaped clamping block is provided with the installation hole and an elongated limit clamping slot, and the installation flange is inserted into the elongated limit clamping slot.

5. The installation structure for a steel frame assembly according to claim 4, wherein an interlocking plate is fixed on one side of each of two side plates of the U-shaped clamping block, the two interlocking plates abut against each other, and one or two installation holes are designed away from the interlocking plates.

6. The installation structure for a steel frame assembly according to claim 5, wherein lower edges of the two side plates are avoidance arc surfaces; and the two side plates have reinforcing ribs.

7. The installation structure for a steel frame assembly according to claim 4, further comprising an L-shaped stopper, wherein a transverse plate of the L-shaped stopper is fixedly connected to the upper transverse plate through a connecting bolt, and a vertical plate of the L-shaped stopper is stopped on one side of the steel frame on a side.

8. The installation structure for a steel frame assembly according to claim 1, wherein the purlin assembly comprises:
a third purlin, wherein a top surface of the third purlin is provided with the installation hole; and
a stationary fixture, wherein the top of the stationary fixture is clamped with the steel frame, and the bottom of the stationary fixture is clamped between a bottom surface of the lower horizontal external flange and the top surface of the third purlin.

9. The installation structure for a steel frame assembly according to claim 8, wherein the top of the main frame plate has an upper horizontal external flange, the upper horizontal external flange is vertically connected to an upward bent upper vertical flange on a side away from the main frame plate, and the upper vertical flange is vertically connected to an upper horizontal internal flange on a side away from the upper horizontal external flange; and
the top of a main fixture plate of the stationary fixture is vertically connected to an upper crimping edge, and the upper crimping edge is crimped with the upper horizontal internal flange; one side of the main fixture plate is vertically connected to a supporting edge, the supporting edge is located below the upper crimping edge, and the supporting edge supports the upper horizontal external flange; one side of the main fixture plate is vertically connected to a lower crimping edge at a position below the supporting edge, and the lower crimping edge is crimped with the elongated head; the bottom of the main fixture plate is vertically connected to a reinforcing crimping edge, and the reinforcing crimping edge is clamped between a bottom surface of the lower horizontal external flange and the top surface of the third purlin.

10. The installation structure for a steel frame assembly according to claim 9, wherein one side of the reinforcing crimping edge has a second clamping slot for the adaptive insertion of the shank of the T-bolt.

11. The installation structure for a steel frame assembly according to claim 2, wherein the purlin assembly comprises: a first purlin, wherein the first purlin is a C-shaped purlin, an upper transverse plate of which is provided with the installation hole.

12. The installation structure for a steel frame assembly according to claim 2, wherein the purlin assembly comprises:
a second purlin, wherein the second purlin is a C-shaped purlin, an upper transverse plate of which has a downward bent installation flange; and
a U-shaped clamping block, wherein a middle plate of the U-shaped clamping block is provided with the installation hole and an elongated limit clamping slot, and the installation flange is inserted into the elongated limit clamping slot.

13. The installation structure for a steel frame assembly according to claim 2, wherein the purlin assembly comprises:
a third purlin, wherein a top surface of the third purlin is provided with the installation hole; and
a stationary fixture, wherein the top of the stationary fixture is clamped with the steel frame, and the bottom of the stationary fixture is clamped between a bottom surface of the lower horizontal external flange and the top surface of the third purlin.
